(19) United States
(12) Patent Application Publication
(10) Pub. No.: US 2018/0346056 A1
(43) Pub. Date: Dec. 6, 2018

(54) Bicycle Hub Quick-Release Axle

(71) Applicant: Canyon Bicycles GmbH, Koblenz (DE)

(72) Inventors: Michael Adomeit, Koblenz (DE); Lutz Scheffer, Garmisch-Partenkirchen (DE); Travor Allen, Odiham (GB); Johannes Thumm, Koblenz (DE); Stephan Vogt, Koblenz (DE)

(21) Appl. No.: 15/579,809

(22) PCT Filed: Jul. 8, 2016
(86) PCT No.: PCT/EP2016/066252

§ 371 Date: Dec. 5, 2017

(30) Foreign Application Priority Data
Aug. 17, 2015 (DE) 20 2015 005 799.3

(51) Int. Cl. B62K 25/02; B60B 35/00

(52) U.S. Cl. CPC B62K 25/02; B62K 2206/00; B62K 2025/025; B60B 35/004

(57) ABSTRACT

A bicycle hub quick-release axle has a shaft. A thread for fixing the shaft in a threaded bore in a dropout is provided at the first end of the shaft. A lever element for screwing the thread into/out of the threaded bore is provided at the second end of the shaft. A receiving space for the lever element is provided within the shaft. The lever element can be pulled out of the receiving space. The lever element when pulled out of the receiving spaced is connected to the shaft via holding elements. By this arrangement, simple screwing-in/unscrewing of the shaft is possible with the aid of the lever element.

The invention relates to a bicycle hub quick-release axle.

For a fixation of a bicycle hub to a bicycle frame, i.e. at the dropouts of the bicycle fork or the dropouts of the rear frame of a bicycle, it is known to use clamping axles. The same have an eccentric so as to allow a clamped fixation of the axle. Such clamping axles require that the dropouts have a slot into which the clamping axles can be inserted. By providing slots in the dropouts, rigidity is reduced in this region. Further, there is a risk that the wheel is mounted with a modified track and a modified camber. This may e.g. result in the brake pads rubbing on the rim or the brake disc rubbing on the brake pads.

Besides such clamping axles, quick-release axles are known for some time. Quick release axles have a shaft provided at one end with a thread or a bayonet. Correspondingly, the dropouts do not have slot-shaped recesses, but bores. One of these bores is provided with a thread into which the quick-release axle is screwed. At the opposite dropout a bore is provided through which the quick-release axle is passed. At the second end of the shaft, i.e. at the end opposite the threaded end, a lever element is provided or may be arranged, to screw the shaft into the thread or unscrew it from the thread. Such lever elements are known in the form of lever elements fixedly connected to the shaft and having an eccentric. However, these have a disadvantage in that, similar to clamping axles, a disturbing lever element is possibly provided.

Further, quick-release axles are known in which an Allen key is used as the lever element. Such quick-release axles have a conventional socket for an Allen key at the second end opposite the thread. These quick-release axles are disadvantageous in that a separate tool is required for screwing-in the quick-release axle, which tool has to be carried along. For example, this may be a quick-release axle from the company Syntace named X-12.

The company Syntace further offers a quick-release axle named X-Fix. This quick-release axle has a hollow space or a receiving space into which an Allen key is inserted. For screwing the quick-release axle in or for unscrewing the same, the Allen key is pulled from the receiving space and is then inserted into a hexagonal socket-shaped opening. This quick-release axle has the disadvantage that the key may be lost and that, further, a relatively large head of the lever element or of the key is arranged outside the quick-release axle also in the inserted state of the key.

It is an object of the present invention to provide a bicycle hub quick-release axle that can be mounted and dismounted in a simple manner.

The object is achieved according to the invention with the features of claim 1.

The bicycle hub quick-release axle of the present invention has a shaft. A first end of the shaft is connected to a thread for fixing the shaft in a threaded bore of a dropout. Similar to known quick-release axles, the dropout is no longer slotted, but has a threaded bore into which the shaft can be screwed. The quick-release axle has a second end connected to a lever element. Using the lever element, the thread can be screwed into and unscrewed from the threaded bore. Further, the shaft is provided with a receiving space for receiving the lever element. Thus, the lever element can be arranged within the mounted quick-release axle.

According to the invention a holding element is provided which connects the lever element to the shaft when the same is pulled out of the receiving space. Thus, according to the invention, the lever element cannot be pulled entirely out of the receiving space. For example, releasing the quick-release axle merely requires pulling the lever element out of the receiving space until a connection between the lever element and the shaft is established via the holding element. Thereafter, the holding element is turned to unscrew or release the shaft. Thus, the holding element acts as a kind of loss prevention device and, at the same time, acts as a connection between the lever element and the shaft element so that a torque can be transmitted.

It is preferred that the holding element has a first holding part arranged at the lever element and a second holding part arranged at the shaft. The two holding parts cooperate when pulled out so that a preferably articulated/hinge-like connection is realized between the lever element and the shaft. The holding element could e.g. also be a cable, a chain or the like. Such a holding element has a length dimensioned such that it is not possible to pull the lever element entirely out of the receiving space. An articulated joint would be realized in this manner as well.

It is particularly preferred that the shaft has a thickening at the second end for forming a head part. The head part may, e.g., have a planar or conical inner side to guarantee a defined engagement at or in the region of the bore in the dropout. In this regard, it is particularly preferred that the second holding part is arranged at the head part of the shaft, in particular inside the head part of the shaft.

In a particularly preferred embodiment the first or the second holding part has protrusions which, in the pulled out position, engage in recesses which form the respective other holding part. The protrusions, which preferably are pins or pinshaped protrusions, are preferably arranged opposite each other to allow for a uniform transmission of force, while it is possible that only a single protrusion is provided, e.g. a spherical thickening or the like.

The recesses preferably for the second holding part and, in a particularly preferred embodiment, are arranged inside the head part. It is further preferred that the recesses are slot-shaped, the slots being closed at an outer end, i.e. on an outward directed side. In a preferred embodiment, as the lever element is pulled out, the two protrusions move into the slots which preferably are also arranged opposite each other, wherein it is not possible to pull out the element completely, since the slots are closed on their outer side. In this pulled-out position it is then possible to turn the lever element and to screw in the shaft or unscrew it.

For an improved application of a torque it is further preferred that the lever element can be pivoted when in the pulled-out position. With respect to the longitudinal axis of the shaft, it is possible in particular to pivot the lever element by 45° to 90°, particularly preferred by 60° to 80°. For this purpose it is preferred that the head part has a groove- or slot-shaped recess on the outer side so as to allow for a pivoting of the lever element in the pulled-out position. The slot/groove may have a corresponding abutment surface in order to limit the pivot angle. Owing to the possibility of pivoting the lever element, the lever arm is not only effectively extended so that the operating forces for generating the necessary torque are smaller, but it is further advantageous that thereby the abutment surfaces between the lever and the groove or the slot become larger. Preferably it is possible to pivot the lever in different positions, in particular smoothly, wherein, due to form fit, a torque can be transmitted on the axle in each position. This has the advantage that the user is free to choose the lever position. It is also possible to define individual predetermined positions at which the lever snaps in, for example. Preferably the lever can be turned freely in the inserted position. Thereby, the position of the lever can be chosen freely, in particular for aerodynamic and aesthetic reasons.

In a preferred further embodiment of the invention fixing element is provided in addition. The fixing element serves to fix the lever element in the inserted position. It is ensured thereby that the lever element does not slip out during the ride. The fixing element is preferably designed such that a rattling of the lever element is avoided as well. The fixing element may e.g. be designed as a bracket engaging over the free end of the lever element in the inserted position, thereby fixing the same. The fixing element preferably is a clamping element of elastic plastic material. In this regard it is sufficient e.g. to provide a plastic element at the free end of the lever element, by which the lever element is clampingly retained in the inserted position when the lever element is inserted. In a further preferred embodiment the fixing element has a ball catch. This is a spring-loaded ball which snaps into a recess in the inserted state. The ball catch may be arranged at the head part of the shaft and snap into a recess in the lever element. The ball catch is preferably arranged in the region of the free end of the lever element and snaps into a recess provided on the inside of the head part, wherein it is particularly preferred that the ball snaps into one of the two recesses in which the protrusions or pins engage in the pulled-out state of the lever element. This has the advantage that no separate additional recess has to be provided.

The invention will be described in more detail hereunder with reference to a preferred embodiment and to the accompanying drawings.

In the Figures:

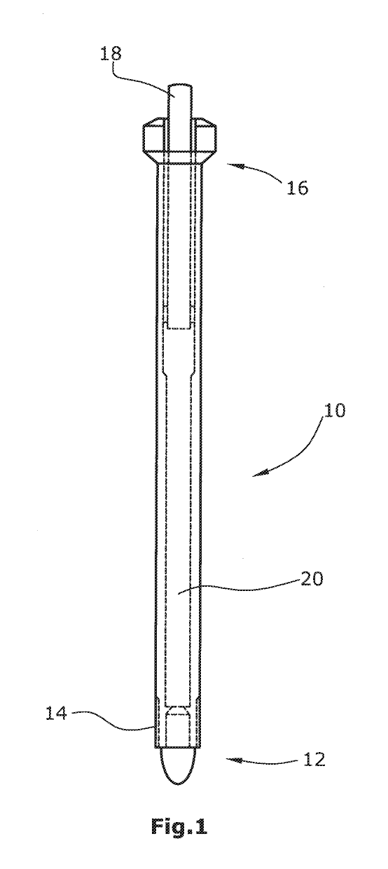

FIG. 1 is a schematic side view of a bicycle hub quick-release axle of the present invention,

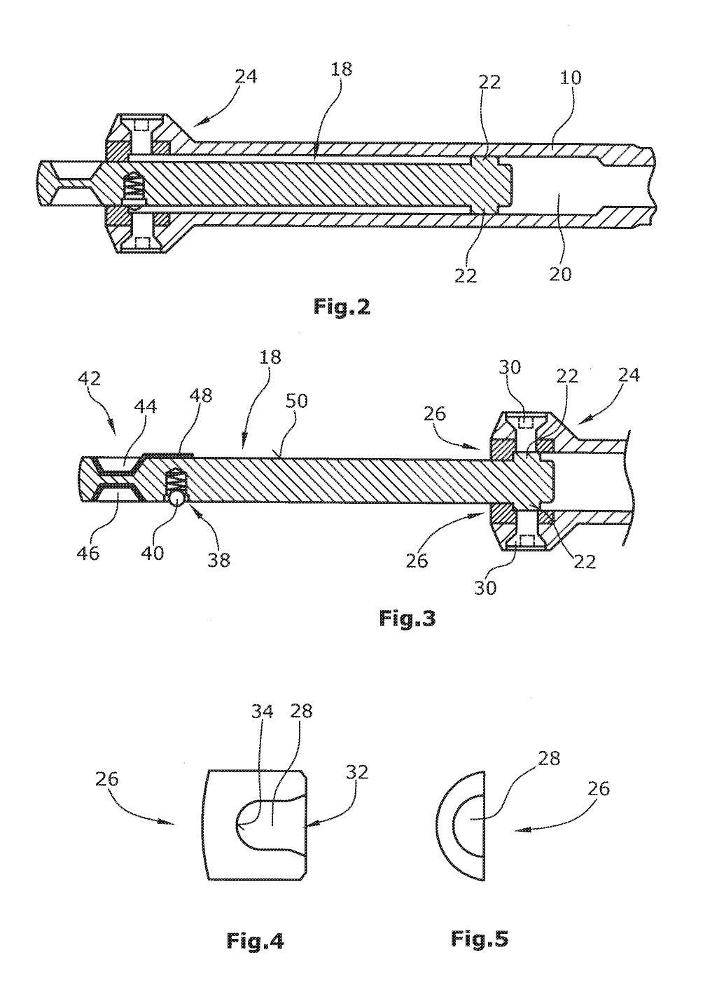

FIG. 2 is a schematic sectional view of the quick-release axle with the lever element inserted,

FIG. 3 is a schematic sectional view of the quick-release axle with the lever element pulled out,

FIG. 4 is a schematic top plan view on a component arranged in the head part of the shaft and forming a slot,

FIG. 5 is a schematic bottom view of the component shown in FIG. 4, and

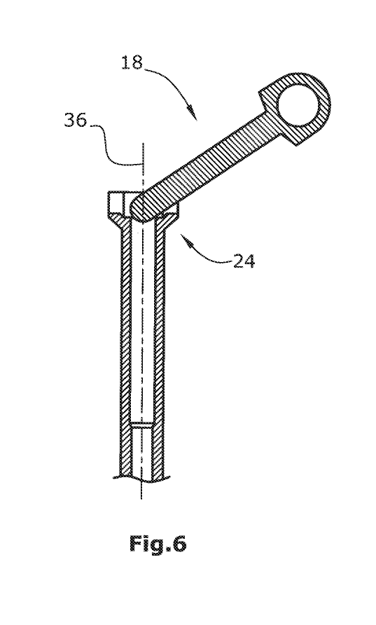

FIG. 6 is a schematic sectional view of the shaft with the lever element pulled out and pivoted.

The preferred embodiment of the bicycle hub quick-release axle of the present invention illustrated in the Figures has a shaft 10. A thread 14 is provided at a first end 12 of the shaft, i.e. the right end in FIG. 1. In the mounted state the thread 14 engages a threaded bore provided at a dropout. This may be the dropout of the bicycle fork shaft or the dropout at the rear frame of the bicycle for receiving the rear wheel hub. A lever element 18 is arranged at the second end 16 opposite the first end 12. The shaft 10 further has a hollow space 20 into which the lever element 18 can be inserted. At its free end, i.e. the right end in FIG. 2, the lever element 18 has first holding parts 22. In the embodiment illustrated the first holding parts 22 are cylindrical, opposite pins or protrusions.

Two components 26 are arranged in a head part 24 of the shaft 10, each having a slot 28. The two slots 28, which are also arranged opposite each other, form second holding parts. The components 26 are fastened in the head part 24 using screws 30. The two slot-shaped recesses 28 are open at the inner end 32 directed towards the receiving space 20. At their opposite side, the slots 28 have an abutment surface 34.

The first holding parts 22 cooperate with the second holding parts 28 and, in the embodiment illustrated, form a holding element. When pulling the lever element 18 out of the inserted position (FIG. 2) to the pulled-out position (FIG. 3), the protrusions 22 slide into the slots 28, while it is not possible to pull the lever element out entirely, since the protrusions 22 abut against the abutment surface 34. It would be possible already in this position to turn the entire quick-release axle using the lever element 18. Even in the inserted position a torque could be transmitted, since the head of the lever element 18 is arranged in the slot or the groove provided at the second end 16 of the shaft 10. To enable the application of a higher torque, the lever element 18 is configured to be pivoted by an angle of e.g. 60° to 80° with respect to a longitudinal axis 36 to the position illustrated in FIG. 6. For this purpose, the head part 24 has a slot extending perpendicular to the longitudinal axis 36, so as to allow for a pivoting of the lever element. Here, the slot extends preferably over the entire width of the head part 24 so that the lever 18 can be pivoted in both directions.

For mounting a wheel, the quick-release axle is first inserted through the unthreaded passage bore at the first dropout, is then passed through the bicycle hub and screwed into the opposite threaded bore provided at the other dropout. After the quick-release axle has been screwed in by applying a corresponding torque via the lever element 18, the lever element 18 is inserted into the receiving space 20.

To ensure a secure retention of the lever element 18 in the receiving space 20, a fixing element 38 is provided in addition. In the embodiment illustrated, the fixing element 38 is a ball catch. The latter has a spring-loaded ball 40. In the inserted state the ball 40 snaps into one of the two slots 28 (FIG. 2).

The lever 18 further has two grip recesses 44, 46 at its free end 42. A plastic element may be placed therein so as to enable a secure and reliable gripping of the lever element. In this regard it is preferred that one of the plastic elements places in the grip recesses has a tongue-shaped protrusion 48. The same is arranged at an outer side 50 of the lever element 18. It is arranged opposite the ball catch 38, wherein the latter may also be omitted. Upon insertion of the lever element 18 into the hollow receiving space, not only the ball catch 38 snaps in, but at the same time a clamping retention is achieved via the elastic tongue 48. Thereby, a rattling of the lever element in the inserted state is avoided.

1. A bicycle hub quick-release axle comprising:
a shaft comprising:
a first end with a thread for fixing the shaft in a threaded bore of a dropout, and
a second end connected to a lever element for screwing/unscrewing the thread into/out of the threaded bore,
a receiving space provided in the shaft for receiving the lever element, and
a holding element connecting the lever element to the shaft when the lever element is pulled out of the receiving space.

2. The bicycle hub quick-release axle of claim 1, wherein the holding element has a first holding part arranged at the lever element, the first holding part cooperating during the pulling with a second holding part arranged at the shaft.

3. The bicycle quick-release axle of claim 2, wherein the second holding part is arranged at a head part of the shaft.

4. The bicycle hub quick-release axle of claim 2, wherein the first or the second holding part has protrusions cooperating with recesses provided in the first or the second holding part.

5. The bicycle hub quick-release axle of claim 4, wherein the first or the second holding part has two opposite recesses.

6. The bicycle hub quick-release axle of claim 4, wherein the protrusions engage in the recesses when the lever element is pulled out of the receiving space.

7. The bicycle hub quick-release axle of claim 1, wherein the lever element is pivotable when in the pulled-out position.

8. The bicycle hub quick-release axle of claim 1, further comprising a fixing element for the fixation of the lever element in the inserted position.

9. The bicycle hub quick-release axle of claim 8, wherein the fixing element has a clamping element of elastic plastic material.

10. The bicycle hub quick-release axle of claim 8, wherein the fixing element has a ball catch.
